(19) United States
(12) Patent Application Publication
(10) Pub. No.: US 2008/0126370 A1
(43) Pub. Date: May 29, 2008

(54) METHOD AND DEVICE FOR DISPLAYING A TREE STRUCTURE LIST WITH NODES HAVING MULTIPLE LINES OF TEXT

(76) Inventor: Feng Wang, Nanjing (CN)

Correspondence Address: SCHIFF HARDIN, LLP;PATENT DEPARTMENT, 6600 SEARS TOWER, CHICAGO, IL, 60606-6473, US

(21) Appl. No.: 11/770,858

(22) Filed: Jun. 29, 2007

(30) Foreign Application Priority Data
Jun. 30, 2006 (CN) 200610089506.X

(51) Int. Cl. G06F 17/30

(52) U.S. Cl. 707/100; 707/E17.005

(57) ABSTRACT

In order to avoid the problem of multiple lines of data not being able to be displayed clearly in a tree structure in a method and a device for displaying a tree structure list with nodes having multiple lines of content, the tree node information is read from the database when a user requests the display of a page. Information such as the line width of the tree node content are calculated and set according to the predetermined length of the content to be displayed in each line on the page and the information of the tree node read from the database. The content of the tree node are written into the page according to the aforementioned parameters. If all of the tree node content cannot be displayed in one line, the content is continually displayed in another line and the tree node is visually marked at the tree node. The marks of the tree nodes are automatically connected together in layers using lines. The content thus is displayed in multiple lines in a tree structure list, and the trunk lines between nodes will not be broken, which allows a user to view the node content in the tree structure list more clearly.

### BACKGROUND OF THE INVENTION

1. Field of the Invention

The present invention relates to the field of network information management, particularly to the visual representation of network data. In particular, the present invention relates to a method for displaying a tree structure list with nodes having multiple lines of content and a device therefor.

2. Description of the Prior Art

Generally, an electronic data processing device is controlled as follows: In order to select the stored, calculated or predetermined data, the data are stored in an addressable storage space according to layers defined in advance. Various layer structures generally have a so-called tree structure with a trunk and layer-associated branches extending from the trunk, which can efficiently and reliably process the program controlling with the pre-programmed programs, and allocate the data correspondingly.

In practice, a tree structure is usually used to express layer relations. Additionally, the tree view web controls of Microsoft are used to display a long text, for example, the layer relations between posts are displayed by a tree view on the left with connection lines called trunk lines. Such applications appear in the modules implementing intercommunication platforms, such as BBS. However, if some node of the controls is endowed with a long string, the controls may display the text in multiple lines, but the lines to connect each node on the left of the web controls will break, thus destroying the tree structure on the page so the display is not consecutive, giving the user wrong or misleading information.

Because a tree structure list on a page may result in the page being over-wide laterally, which makes it inconvenient to view other content on the same page, a page with fixed width is embedded in the page. The tree structure list is displayed on the embedded page, such that the display of the other content is not affected. In this case, the tree view has enough length in the extended page to accommodate more content (which can be implemented by a scroll bar). All of these methods are complicated and cannot visually display a tree structure with long content, which increases the difficulty for a user.

### SUMMARY OF THE INVENTION

An object of the present invention is to provide a method and a device for displaying a tree structure list with nodes having multiple lines of content, which solve the problem of the trunk lines being broken when using the conventional tree structure list to display multiple lines of records. The result achieved by the method and device should be a clear display of the whole list.

The inventive method for displaying a tree structure list with nodes having multiple lines of content includes the following steps:

Step 1, storing all the information of the tree nodes of a tree structure list into a network database;

Step 2, reading out at least the layer information and title information or content information of each said tree node from said network database when a user requests the display of a page;

Step 3, calculating the length of the content of each said tree node to be displayed according to the title information or content information of the node, then obtaining the line width occupied by the content of the tree node to be displayed from the length divided by the predetermined length of the line corresponding to the tree node;

Step 4, setting the width of the web page table corresponding to the tree node according to said width, setting the length of the trunk line between the tree nodes according to the width of the web page table, then writing the content of each said tree node to be displayed into the corresponding web page table according to the layer information about the tree node, wherein when all of the title information or the content information of the tree node cannot be displayed in one line, continually displaying the information or content in another line, then drawing each said trunk line and the lines connecting said trunk lines with said tree nodes to complete the displaying of the tree structure list.

In step 3, in an embodiment the read title information or content information of each tree node can be transformed into ASCII code. The length occupied by each character is calculated, and all lengths of characters in the read information are added, so as to obtain the length of the content of the tree node to be displayed. The length of the content to be displayed in each line of the tree node is obtained according to the predetermined length of the content to be displayed in each line on the page and the layer information of the tree node. The line width occupied by the content of the tree node to be displayed is obtained from the length of the tree node content divided by the length of the content of the tree node to be displayed in each line.

In another embodiment, after the tree node content is written, step 4 further includes visually marking the tree node before the tree node, then drawing all of the trunk lines and the lines connecting said trunk lines with the mark of the tree node.

The method can further include an input step, wherein when a user operates on the tree structure list so as to enter user's operation information and the adding, deleting, modifying operations are performed by a processing unit, which performs steps 1 to 4.

In step 2, the data read from the network database can further include the user's ID.

The method can further include an identity confirming step, including confirming the user's identity and controlling the user's operations before the user operates on the tree nodes on the page.

The method can further include a refreshing step, causing steps 2 to 4 to be repeated.

The device for displaying a tree structure list with nodes having multiple lines of content includes:

a database that stores the content information of tree nodes and the layer relation information of tree nodes;

a processing unit connected with the database, that retrieves the database and calculates display parameters of the tree nodes, the parameters including the line width occupied by the tree node content and the length of the connection lines between the tree nodes;

a drawing unit connected with the processing unit, that draws all of the tree node content and the connection lines between each tree node according to the display parameters provided by the processing unit; and

a display unit connected with the drawing unit that displays the processed result of the drawing unit to the user.

The device can further include an input unit connected to the processing unit, to receive user's operation information and to enter it to the processing unit.

The device can further include an identity confirming unit connected to the processing unit that confirms a match between the user's identity and the operations.

The device can further include a refreshing unit connected to the processing unit that sends an actuating signal to the processing unit that actuates the processing unit to re-calculate the display parameters of the tree node, and commands the drawing unit re-draw the tree nodes on the display unit.

The advantage of the present invention is that the content is displayed in multiple lines in a tree structure list, and the trunk lines between each node will not be broken, which allows the user to view the content of the nodes in the tree structure list more clearly, thus avoiding the confusion to the user in the operations on the tree structure list, resulting from the broken trunk lines.

### DESCRIPTION OF THE DRAWINGS

FIG. 1 is a flowchart of an embodiment of the method according to the present invention.

FIG. 2 is a block diagram of an embodiment of the device according to the present invention.

FIG. 3 is a schematic illustration of the tree structure list according to the present invention.

### DESCRIPTION OF THE PREFERRED EMBODIMENTS

In the following, the present invention will be described in detail in combination with the accompanying figures.

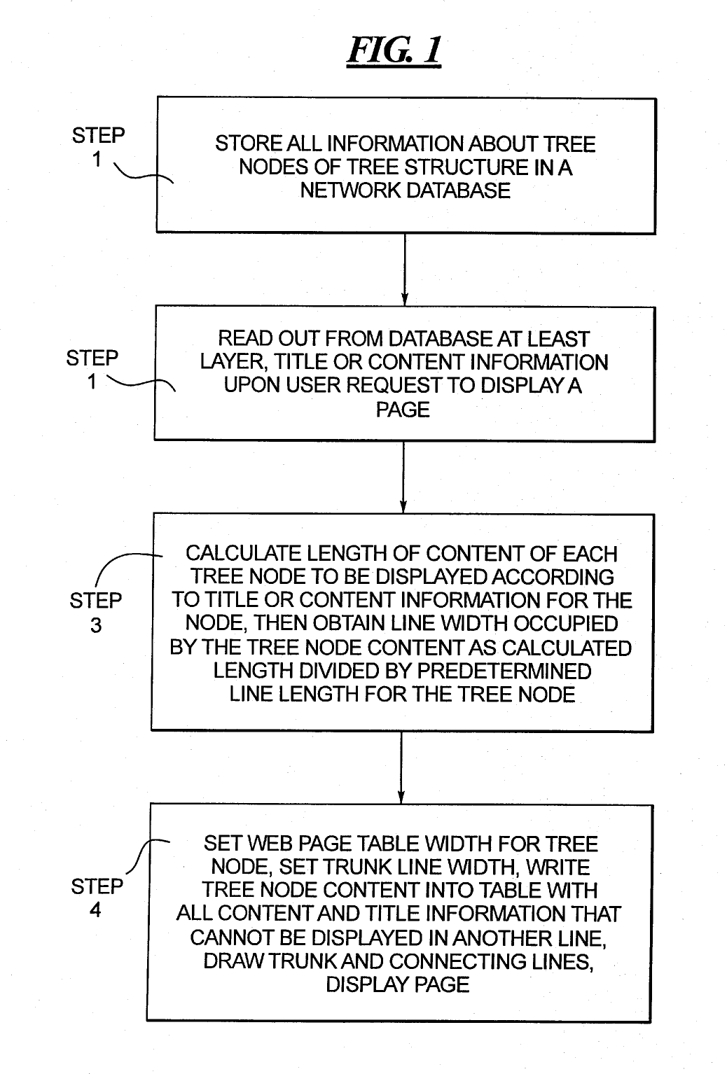

FIG. 1 is a flowchart of the method according to the present invention. First, all of the content of a tree structure list to be displayed should be stored in a database, and the relations between the tree nodes of the tree structure list and the relations between the tree nodes and the trunk also are all stored in the database. This can be done using the dynamic database object (ADO) technology or other database technologies. The following items, without being limited thereto, can be included in the tables of the database: a node ID, node content (including titles and/or content), a parent node ID, son node IDs, the number of son nodes, submitters, and table items such as document attachments may also be included.

When content is to be displayed the second step is performed to retrieve the information of the tree nodes in the database, which includes the node layer information of the tree structure list (the parent node ID, etc.) and the title information or the content information.

At the third step the display parameters of the tree structure list are determined, a table is defined for displaying the content of one tree node, and the parameters of the table are set according to the parameters such as the display rules of different layer nodes, the maximum number of words, the space between words, the line width for displaying, the space between lines, etc. The display position for the table is set according to the layer relations between this node and the parent node thereof. For example, the node is displayed under its parent node and indented a width of two English characters. Because the character width of an English character is different from that of a Chinese character, the number of English characters displayed in one line of same length is different from that of Chinese characters. Hence the maximum length for displaying in one line is set according to the type of content, and the unit may be character, centimeter (cm), or millimeter (mm), which is determined before generating a web page or designing a system. For example, in order to make the tree nodes uniform on both sides, the length of one line is 10 cm, or 10 Chinese characters or 15 English characters or a mix of 12 Chinese characters and English characters are displayed in one line. For example, a node title consists of Chinese characters and English characters. The string is derived from the database and transformed into a Char array, its ASCII codes are obtained according to character maps, and then which characters are English characters or Chinese characters can be judged and made known using the ASCII codes. The width of Chinese characters is transformed into the width of English characters, or the width of English characters is transformed into the width of Chinese characters. For example, the width of one Chinese character is equal to the width of about one and a half English characters. If it is predetermined to display 13 English characters in each line, assuming the tree node is a son node of the first layer node, that is to say a width of 2 English characters should be indented, thus the predetermined width of content displayed in one line becomes 11 English characters. If the node content is “ABC ** DEFGHIJKL” (wherein each asterisk denotes a Chinese character), the width transformed corresponds to that of 15 English characters, the content “ABC ** DEFGH” will be displayed in the fist line, and the content “IJKL” will be displayed in the second line. The space between words in one line is adjusted (for example, if there are fewer Chinese characters than English characters in one line, then the space between words needs to be increased); the length of the content of the tree node to be displayed is calculated (the step for transforming the width of English characters to that of Chinese characters being reversible), then the number of lines to display the string is obtained from the length divided by the fixed display length (13 English characters). In this example, the number of lines is two. The parameter for line space can be set slightly bigger when displaying Chinese characters or the mixed content of Chinese characters and English characters, because Chinese characters are generally taller than English characters. Finally, the line width occupied by tree node content is obtained. In this example, only the title information of the tree nodes is displayed, such that a user can display all of the text content of the tree node by clicking the title to pop up a dialog box. Likewise, all of the content of the tree node can also be directly displayed, including all of the text information of the title and the content.

At the fourth step, the tree structure list is drawn according to the parameters determined in the above step. This can be done using the active server page .net (ASP.net) technology. The line width occupied by the table is customized according to that of each tree node. This can be slightly bigger than the line width occupied by each tree node content. The corresponding tree node content is written into the table, and then the length of the trunk lines corresponding to the tree node is set (i.e. the dashed lines as shown on the left in FIG. 3) according to the line width occupied by the table corresponding to the tree node, such that the trunk lines on the left will not be broken when displaying multiple lines of content in the tree structure list. Furthermore, visual node marks are added before the node content. Said trunk lines and the lines connecting the trunk lines with the marks are drawn using lines, especially dashed lines. In particular, the marks and connection lines can be displayed on the left end or the right end in the tree structure list. FIG. 3 schematically illustrates that tree node marks are indented according to the layer information between tree nodes while the content of tree nodes is uniform.

When a user refreshes a page, the third step to the fourth step is repeated to display the content updated in the database.

When a user wants to modify a tree node content, the user identity confirming step is further required, to ensure that only the authorized user can modify, delete, and add a tree node and the content thereof.

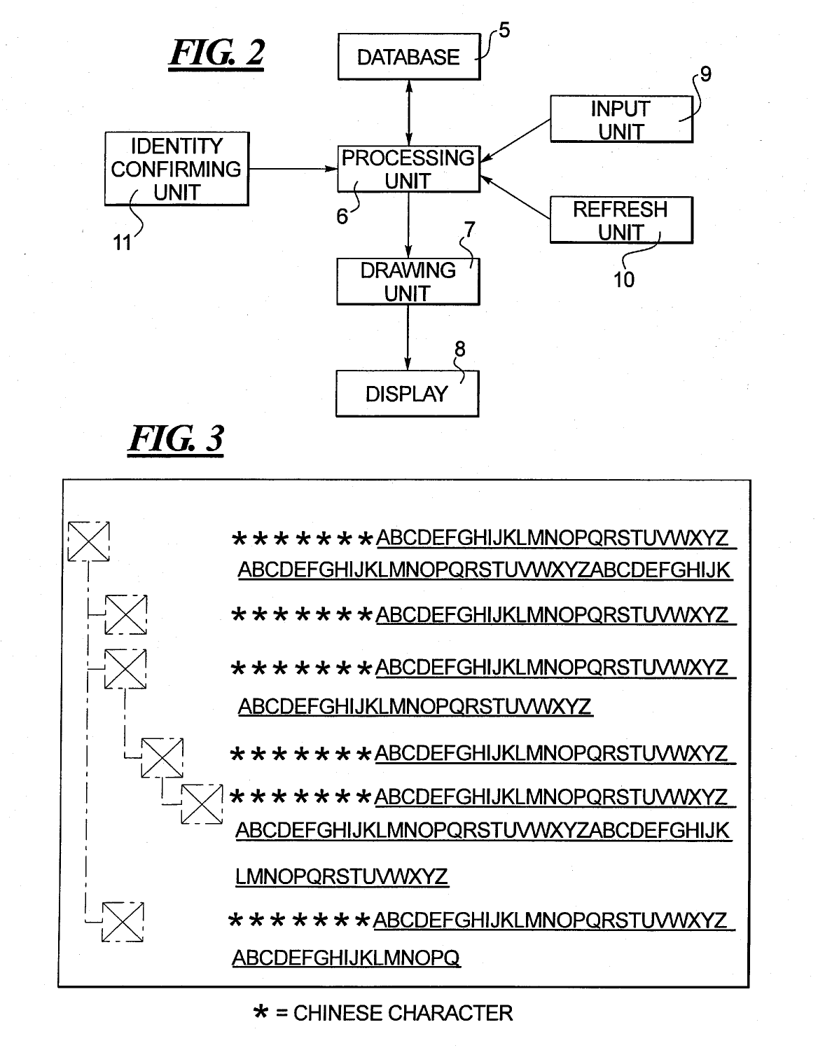

FIG. 2 is a block diagram of the device according to an embodiment of the present invention. The device includes a database 5 for storing the content information of tree nodes and the layer relation information of the tree nodes including text content and pictures. A processing unit 6 is connected with the database 5, for retrieving the database and calculating the display parameters of the tree node, including the line width occupied by the tree node content and the beginning and ending position of each node in the whole tree structure list. A drawing unit 7 is connected with the processing unit 6, for drawing the whole tree structure list according to the parameters provided by the processing unit. A display unit 8 is connected with the drawing unit 7, for displaying the outputted tree structure list to the user.

The device further includes an input unit 9 connected with the processing unit 6, allowing a user to input information in the tree structure list, obtaining the position of the tree node corresponding to the current operations, and transmitting the information to the processing unit. The entered information and the information of the current node are transmitted to the database by the processing unit, and the node information is stored in or deleted from the database.

The device further includes a refresh unit 9 connected with the processing unit 6, for sending an actuating signal to the processing unit 6, that actuates the processing unit 6 to recalculate the display parameters displayed by the tree structure list, and then to command the drawing unit 7 to redraw the tree structure list on the display unit 8.

The drawing unit 7 draws the whole tree structure list according to the data information provided by the processing unit 6. A schematic illustration of the tree structure list according to the present invention is shown in FIG. 3. The tree structure list drawn by the drawing unit 7 is the tree view including the broken lines and the tree node marks, wherein the layer relations between the tree nodes are indicated by the broken lines on the left. When the content of the tree node is too long to be displayed in one line, the word for the broken point is located according to the number of words to be displayed in one line which emitted as an output by the processing unit 6, and the subsequent content of the tree node is continually displayed in another line, and the whole tree structure list is drawn.

The input unit 9 can implement the functions such as adding, editing, deleting, etc. The input unit 9 receives an operation on a tree node as an input from a user. When a tree node is selected, the position information of the tree node is returned to the processing unit 6. When the user selects an option such as deleting, or adding, or editing, the tree node content can be operated on. When the processing is completed and the user confirms completing the operation, the processing unit 6 carries out the corresponding operation on the database 5 according to the operation selected by the user, and the information content and the position information of the tree node are modified.

The device further includes a user identity confirming unit 11 connected with the processing unit 6. Before a user is permitted to perform an operation on the tree structure list, the user identity confirming unit confirms the user's identity to determine whether the user has the authorization to perform the operation. If the user does not have the authorization to perform the operation, an alarm will be given. The alarm information will be shown on the display unit 8, and the device will make no response to the operation on the tree structure list conducted by the user, and the process will return to the preceding step.

An advantage of the present invention is that the content is displayed in multiple lines in a tree structure list, and the trunk lines between each node will not be broken, which allows the user to view the content of the nodes in the tree structure list more clearly, thus avoiding the confusion to the user in the operations on the tree structure list, resulting from the broken lines.

Although modifications and changes may be suggested by those skilled in the art, it is the intention of the inventor to embody within the patent warranted hereon all changes and modifications as reasonably and properly come within the scope of the inventor's contribution to the art.

I claim as my invention:

1. A method for displaying a tree structure list with nodes having multiple lines of content, said method comprising the steps of:
storing information identifying a plurality of tree nodes of a tree structure list in a network database, each tree node comprising at least layer information, title information and content information;
for each of said tree nodes, electronically reading out at least one of said layer information, said title information or said content information from said network database, as read out information, upon a user request to display a page representing said tree structure;
automatically electronically calculating a length of content of each of said tree nodes to be displayed according to said read out information, and automatically determining a line width occupied by said content of each tree node to be displayed from said length divided a predetermined length of the line corresponding to the respective tree node to be displayed; and
automatically setting a width of a web page table corresponding to the tree node according to said line width, and setting a length of a trunk line between the respective tree nodes dependent on the width of the web page table, and writing the content of each tree node to be displayed into the corresponding web page table according to the layer information associated with the tree node, and if all of the title information or all of the content information of the tree node cannot be displayed in one line, continually displaying said title information of content information in another line, and automatically drawing said trunk line and lines connecting said trunk line with the respective tree nodes to complete display of said tree structure list.

2. A method as claimed in claim 1 comprising automatically transforming said read out information into ASCI code, and calculating a length occupied by each character of said content, and adding all lengths of the characters in the read out information to obtain said length of said content of said tree node to be displayed, obtaining said predetermined length of the content to be displayed in each line of the page and obtaining the layer information of the respective tree nodes, and determining the line width occupied by the content of the tree node to be displayed from the length of the tree node content divided by the length of the content to be displayed in each line.

3. A method as claimed in claim 1 comprising, after writing said tree node content, visually marking said tree node at said tree node, and then drawing said trunk line and said lines connecting said trunk line with said visual mark.

4. A method as claimed in claim 1 comprising allowing a user to interact with said database to operate on said tree structure list stored therein, as a user modification, and automatically modifying said tree structure according to said user input before reading out said read out information.

5. A method as claimed in claim 1 comprising including a user identifier in said read out information.

6. A method as claimed in claim 5 comprising electronically confirming an identity of a user, using said user identifier, before allowing a user to interact with said database.

7. A method as claimed in claim 1 comprising, upon request, refreshing said read out information, the calculation of said length, the setting of said width, and the drawing of said lines.

8. A device for processing a tree structure list with nodes having multiple lines of content, said device comprising:
a database that stores content information of tree nodes of a tree structure list and layer information of the respective tree nodes;
a processing unit connected to said database that retrieves said content information and said layer information from said database and automatically calculates display parameters for the respective tree nodes, said parameters including line width occupied by tree node content for each tree node and a length of connection lines between the respective tree nodes;
a drawing unit connected to said processing unit that draws all of the tree node content and connection lines between respective tree nodes, as a display result, according to said display parameters provided by said processing unit; and
a display unit connected to said drawing unit that visually displays said display result from said drawing unit.

9. A device as claimed in claim 8 comprising an input unit connected to said processing unit that allows a user to enter information that modifies said tree structure in said database.

10. A device as claimed in claim 9 comprising an identity confirming unit connected to said processing unit that confirms an identity of the user before permitting said user to operate on said tree structure stored in said database.

11. A device as claimed in claim 8 comprising a refresh unit connected to said processing unit that, upon a user input, emits a signal to said processing unit that causes said processing unit to recalculate said display parameters and to command said drawing unit to redraw said tree nodes at said display unit according to a new display result.
